(19) United States
(12) Patent Application Publication
(10) Pub. No.: US 2009/0094359 A1
(43) Pub. Date: Apr. 9, 2009

(54) Local Area Network Management

(75) Inventors: Niall Seamus McDonnell, Portland, OR (US); Richard Krull, Portland, OR (US); Daniel Bame, Beaverton, OR (US)

Correspondence Address: Robert D. Shedd;Thomson Licensing LLC, PO Box 5312, PRINCETON, NJ, 08543-5312, US

(73) Assignee: THOMSON LICENSING, Boulogne Billancourt (FR)

(21) Appl. No.: 11/922,968

(22) PCT Filed: Mar. 2, 2006
(86) PCT No.: PCT/US2006/007433

§ 371 Date: Dec. 26, 2007

Related U.S. Application Data
(60) Provisional application No. 60/702,441, filed on Jul. 26, 2005.

(51) Int. Cl. G06F 15/173

(52) U.S. Cl. 709/224

(57) ABSTRACT

There is provided a method for managing a Local Area Network (LAN) having at least one video server in signal communication with a plurality of clients. In one embodiment of the present invention, the method includes providing a lossless Transmission Control Protocol/Internet Protocol (TCP/IP) Virtual Local Area Network (VLAN) fabric within the LAN. The method further includes providing a shared file system on the at least one video server. Moreover, the method includes deterministically managing isochronous access to the shared file system on the at least one video server by the plurality of clients, over the VLAN fabric, utilizing at least one Internet Small Computer System Interface (ISCSI) block protocol, to provide lossless delivery of video applications from the at least one video server to any of the plurality of clients without invoking TCP error recovery mechanisms.

### CROSS-REFERENCE TO RELATED APPLICATIONS

This application claims the benefit of U.S. Provisional Patent Application entitled “LAN MANAGEMENT TECHNIQUE”, filed Jul. 26, 2005, which is incorporated by reference herein in its entirety.

### FIELD OF THE INVENTION

The present invention relates generally to local area networks (LANs) and, more particularly, to local area network management.

### BACKGROUND OF THE INVENTION

In a video delivery system coupled to a network such as a local area network (LAN), a sequence of events/conditions can often occur that causes glitches in the delivery of video over the network. For example, Ethernet switches typically used in LANs do not provide end-to-end flow control for traffic on the Ethernet level. Moreover, Transmission Control Protocol (TCP) traffic can cause stalls in normal traffic patterns. Further, routers and switches may drop frames on occasion. The dropping of Ethernet frames will result in the use of error recovery functions by TCP. TCP error recovery may cause stalls in the video stream, causing glitches in the video delivery system.

In an attempt to overcome some of the attendant problems in the prior art relating to LANs, Network Attached Storage (NAS) has been used to provide data flow over a Gigabit Ethernet to a centralized storage. Disadvantageously, such an approach has higher Input/Output (I/O) latencies, and is susceptible to losing control of I/O buffering due to the added buffering in the NAS protocols layers. Also, in such an approach, there is no end-to-end flow control on the transport layer (Ethernet), and switches may drop packets due to traffic congestion policies. Moreover, such an approach is unable to leverage and utilize the underlying storage bandwidth fully. All of these issues combine to provide inefficiencies, stalls, and ultimately, dropped payloads.

Accordingly, it would be desirable and highly advantageous to have methods for local area network (LAN) management that overcome the above-described problems of the prior art.

### SUMMARY OF THE INVENTION

These and other drawbacks and disadvantages of the prior art are addressed by the present invention, which is directed to local area network (LAN) management.

According to an aspect of the present principles, there is provided a method for managing a Local Area Network (LAN) having at least one video server in signal communication with a plurality of clients. The method includes providing a lossless Transmission Control Protocol/Internet Protocol (TCP/IP) Virtual Local Area Network (VLAN) fabric within the LAN. The method further includes providing a shared file system on the at least one video server. Moreover, the method includes deterministically managing isochronous access to the shared file system on the at least one video server by the plurality of clients, over the VLAN fabric, utilizing at least one Internet Small Computer System Interface (ISCSI) block protocol, to provide lossless delivery of video applications from the at least one video server to any of the plurality of clients without invoking TCP error recovery mechanisms.

These and other aspects, features and advantages of the present invention will become apparent from the following detailed description of exemplary embodiments, which is to be read in connection with the accompanying drawings.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a local area network in accordance with one embodiment of the present invention; and

FIG. 2 depicts a flow diagram of a method for managing a local area network (LAN) in accordance with one embodiment of the present invention.

### DETAILED DESCRIPTION

The present invention is directed to managing a Local Area Network (LAN) having at least one server and a plurality of clients using Internet Small Computer System Interface (ISCSI) to provide deterministically managed isochronous access to video applications on a server by clients. The clients are provided with lossless delivery of video applications from the server without invoking Transmission Control Protocol (TCP) error recovery mechanisms. Although the present invention will be described primarily within the context of a LAN having a specific configuration and components, the specific embodiments of the present invention should not be treated as limiting the scope of the invention. It will be appreciated by those skilled in the art and informed by the teachings of the present invention that the concepts of the present invention can be advantageously applied in substantially any network having at least one server and a plurality of clients. That is, it will thus be appreciated that those skilled in the art will be able to devise various arrangements that, although not explicitly described or shown herein, embody the principles of the invention and are included within its spirit and scope.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, for example, any elements developed that perform the same function, regardless of structure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

Furthermore, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined resides in the fact that the functionalities provided by the various recited means are combined and brought together in the manner for which the invention calls. It is thus regarded that any means that can provide those functionalities are equivalent to those shown herein.

In accordance with various embodiment of the principles of the present invention, methods are provided for local area network (LAN) management. Some of the many attendant advantages/features of LAN management as described herein include, but are not limited to, low latency, the avoidance of dropped frames, and the providing of end-to-end flow control through the LAN. Moreover, the present invention advantageously allows an Ethernet LAN, running Internet Small Computer System Interface (ISCSI), to provide similar features for storage as a Fiber Channel Small Computer System Interface (FC-SCSI). To support the isochronous transfer of data, the present invention provides, among other features described herein below, uninterrupted traffic flow throughout the LAN.

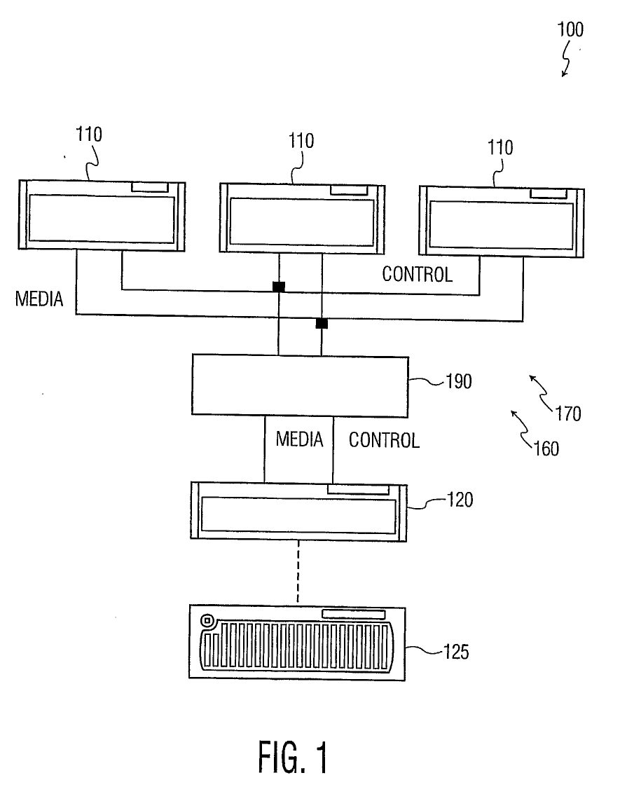

FIG. 1 depicts a high level block diagram of a Local Area Network (LAN) 100 in accordance with an embodiment of the present invention. The LAN 100 includes a plurality of clients 110 connected to a server 120 having a server storage element 125. Moreover, the LAN 100 can include switches 190 and hubs (not shown) for interconnecting the various elements such as the clients 110 and the server 120.

In the illustrative embodiment of FIG. 1, the plurality of clients 110 are connected to the server 120 over a Genet Fabric utilizing two VLANs 160 and 170. In one embodiment of the present invention, one of the two VLANs is used for media data and the other one of the two VLANs is used for control data. In this way, network traffic can be segregated to provide uniform traffic patterns within the LAN 100.

It is to be appreciated that while only one server 120 is depicted in the LAN 100 of FIG. 1, a LAN in accordance with the present invention can include one or more servers. Moreover, a fabric other than a Genet Fabric can also be employed. Thus, it is to be further appreciated that given the teachings of the present invention provided herein, these and various other LAN configurations and modifications thereto may be included in accordance with the principles of the present invention, while maintaining the scope of the present invention.

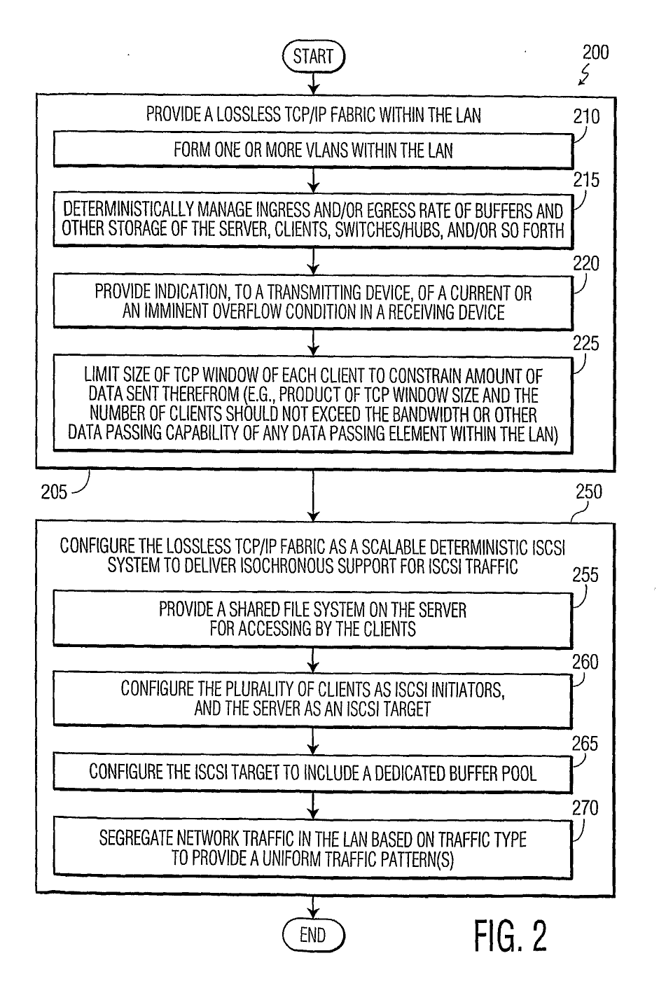

FIG. 2 depicts a flow diagram of a method 200 for managing a local area network, such as the LAN 100 of FIG. 1, in accordance with one embodiment of the present invention. Accordingly, the method steps will refer to the elements of the LAN 100. Of course, given the teachings of the present invention provided herein, the method 200 may be applied to other LANs having other configurations, while maintaining the scope of the present invention.

It is to be appreciated that while the steps of FIG. 2 are numbered, no particular ordering is mandated or implied. Rather, the steps may be performed in any working order, as readily determined by one of ordinary skill in this and related arts, while maintaining the scope of the present invention.

At step 205, a lossless Transmission Control Protocol/Internet Protocol (TCP/IP) fabric is established within the LAN 100. It is to be appreciated that in various embodiment of the present invention, the lossless TCP/IP fabric provides a medium such that TCP error correcting mechanisms are not invoked, thereby providing the underpinnings of a data communication system having low latency and deterministic behavior. It is to be further appreciated that step 205 may include one or more of the following steps 210-225 to support the lossless TCP/IP fabric.

For example, at step 210, one or more Virtual Local Area Networks (VLANs) may be formed within the LAN 100 for segregating application traffic on the VLANs based on traffic type to provide uniform traffic patterns. For example, in an exemplary embodiment, a first set of VLANs (having one or more members) can be configured for use with isochronous traffic (e.g., media data), and a second set of VLANs (having one or more members) may be configured for use with control data. As such, any switches/hubs within the LAN can be configured to have a first setting for the isochronous traffic and a second setting for the non-isochronous traffic, the settings being used for directing the network traffic to the appropriate VLAN.

At step 215, the ingress rate and/or the egress rate of buffers or any other storage devices in the server 110, the plurality of clients 120, the switches 190, hubs, and so forth are deterministically managed. For example, the flow control function of any element(s) of the LAN 100 may be used to manage the ingress rate and/or the egress rate of that element or another element(s), for example, utilizing a “backpressure” signal from a device having or about to have an overflow condition.

At step 220, indications can be provided to a transmitting device, of a current or an imminent overflow condition in a receiving device, wherein the transmitting and receiving devices can be any elements of the LAN 100.

At step 225, the size of the Transmission Control Protocol (TCP) window of each of the plurality of clients 120 may be limited to constrain the amount of data capable of being sent therefrom. In an exemplary embodiment, the TCP window is constrained such that the product of the TCP window size and the number of the plurality of clients (illustratively three in FIG. 1) does not exceed a bandwidth or other data passing capability of any data passing element within the LAN 100 (including the clients 110, the server 120, and any switches or hubs). The method 200 then proceeds to step 250.

At step 250 and with reference to the embodiment of the present invention of FIG. 1, the lossless TCP/IP fabric is configured as a scalable deterministic ISCSI system to deliver isochronous support for ISCSI traffic. It is to be further appreciated that step 230 may include one or more of the following steps 255-270 to support the isochronous delivery of ISCSI traffic.

For example, at step 255 a shared file system is provided for the server 120 and the plurality of clients 110.

At step 260, the plurality of clients 110 can be configured as ISCSI initiators and the server 120 may be configured as an ISCSI target.

Moreover, at step 265, the ISCI target (i.e., the server 120) can be configured to include a dedicated buffer pool.

At step 270, the ISCSI traffic may be segregated onto the lossless TCP/IP VLANs to provide uniform traffic patterns. For example, in an exemplary embodiment, all isochronous traffic may be directed to the first set of VLANs, and all non-isochronous traffic may be directed to the second set of VLANs. The non-isochronous traffic may include, for example, the control data.

A further description of the principles of the present invention will be herein described in accordance with an exemplary embodiment thereof. Given the teachings of the present principles provided herein, it is to be appreciated that variations of the exemplary embodiment may be readily determined and implemented by one of ordinary skill in this and related art while maintaining the scope of the present invention.

In the exemplary embodiment, the lossless TCP/IP fabric is provided and configured such that TCP error recovery mechanisms are suppressed (not invoked). In this way, stalls in the delivery of video applications due to the TCP error recovery mechanisms are avoided.

TCP is a reliable delivery protocol and, as such, if the underlying fabric drops packets in transmission, TCP will invoke error recovery retry policies to ensure the data arrives at the destination. If a switch in a fabric has a port with many clients bursting large amounts of data to that port, then the carrying capacity of that port may be exceeded. Ethernet fabric switches implement a congestion control policy by throwing away Ethernet packets when a port's buffer is over-run. This forces TCP error recovery to be invoked. The TCP protocol will detect this missing packet and retry at a later time. If congestion continues, packets will continue to drop and TCP will limit the performance of the transfer and may fail the transfer. TCP error recovery algorithms can reduce bandwidth and severely impact latencies and determinism. A system desiring low latency and deterministic behavior must protect against invoking the TCP error recovery algorithms.

Moreover, in the exemplary embodiment, ISCI is utilized instead of NAS to provide an overall system having end-to-end flow control. In this way, a lossless flow of video data may be achieved from the server 120 to any of the plurality of clients 110 with lower latency and with end-to-end flow control as compared to NAS.

Typical NAS client server protocols add additional layers of buffering on both the client and the server. Applications that use those protocols do not control the client buffering characteristics nor the servers buffering/flushing characteristics. Typically, the NAS server is an IT server that is tuned for sequential access. If an application has isochronous requirements, yielding control to buffering characterization on both the client and server will yield inefficiencies. For example, if the application involves fast forward to fast reverse through material for a video effect, typical NAS file-servers are not designed to respond efficiently.

In contrast, SCSI block traffic is a low latency protocol that is capable of transferring data quickly, with no intermediary layers. Using SCSI block protocols, coupled with a shared file-system in accordance with the present invention, yields low latencies and control of buffering policies throughout the data flow paths. Running SCSI block protocols over Genet requires implementation of the ISCSI protocol, which is a SCSI block protocol implemented over TCP/IP.

Further, in the exemplary embodiment of the present invention, an integrated ISCSI bridge is utilized, and may be employed with a dedicated buffer pool in the server 120, to provide efficient, responsive SCSI block processing over the fabric. Thus, the clients are configured as ISCSI initiators and the server is configured with ISCSI target capability.

Also, in the exemplary embodiment, data segregation and directed traffic flow based on traffic type are utilized to provide isochronous and deterministic transfers within the LAN. For example, in typical IT fabric environments there are many applications moving data, each with their own I/O characteristics. These disparate data flows tend to interfere with predictability. To support isochronous and deterministic transfers in accordance with the present invention, all isochronous traffic is directed onto one VLAN, and any other kinds of traffic should not be permitted on that VLAN. In this way, a uniform traffic pattern is obtained. There should be no unknown application or unknown device bursting large amounts of data without constraints.

Additionally, in embodiments of the present invention, control of the TCP window size is used on the clients to limit the amount of traffic that can be burst at one time from each client. TCP does supply an end-to-end flow control mechanism and can support lossless transfers, absent failed hardware and with sufficient buffer management provided in the fabric to handle the worst case burst from all clients simultaneously. TCP traffic can burst a limited amount of data before an acknowledgement is received from the destination; this is referred to as the TCP Window Size. Without receipt of an acknowledgement, the transfer will stop once the Window Size has been sent. Limiting the TCP window size on the clients limits the amount of traffic that can be burst at one time from each client.

Thus, in embodiments of the present invention, switches may be selected that allow VLAN management, with flow-control capability and with deep buffers at the ports. VLAN management allows traffic segregation so that all ISCSI traffic can be isolated on its own VLAN. Enabling flow-control allows the switch port, when receiving data, to provide back-pressure to a sending NIC when the switch input port buffer reaches a threshold. Deep buffers on the switch ports should support the TC Window Size multiplied by the number of clients sharing the port buffer.

Further, NICs with flow control capability may be selected to provide back pressure to the switch if necessary and with the ability to configure reasonable resources to handle bursty transfers.

Devices that provide good internal performance should be selected so that the TCP data flow is not constrained by the internal architecture of the hardware or software, for example, all end points, initiators or targets, can run at full fabric speed when in operation. Thus, it is preferable to provide an end-to-end full bandwidth solution and manage the traffic flow such that under worst case conditions there is no congestion in the system.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably but not necessarily implemented as an application program and/or drivers tangibly embodied on a program storage unit. The application program and/or drivers may be uploaded to, and executed by, a machine comprising any suitable architecture. For example, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or part of a driver, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Having described various embodiments for LAN management (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. As such, the appropriate scope of the invention is to be determined according to the claims, which follow.

1. A method for managing a local area network having at least one server in signal communication with a plurality of clients, the method comprising:
establishing a lossless virtual local area network fabric within the local area network;
establishing a shared file system on the at least one server; and
managing access to the shared file system on the at least one server by the plurality of clients over the virtual local area network fabric to provide lossless delivery of applications from the at least one server to any of the plurality of clients without invoking error recovery mechanisms.

2. The method of claim 1, wherein said at least one server comprises at least one video server and said applications comprise video applications.

3. The method of claim 1, wherein said lossless virtual local area network fabric comprises a lossless Transmission Control Protocol/Internet Protocol (TCP/IP) virtual local area network fabric.

4. The method of claim 1, wherein said lossless delivery is provide utilizing an Internet Small Computer System Interface (ISCSI) block protocol.

5. The method of claim 1, wherein said error recover mechanism comprises a TCP error recovery mechanism.

6. The method of claim 1, wherein said managing step comprises managing bandwidth and latency to provide access to the shared file system at wire speed over the virtual local area network fabric.

7. The method of claim 1, further comprising utilizing the virtual local area network fabric to segregate network traffic based on traffic type so as to provide uniform traffic patterns.

8. The method of claim 11, wherein the local area network includes at least one switch, each of the at least one server and the plurality of clients includes a network interface card, each of the at least one switch and the network interface card include an ingress buffer and an egress buffer, and said managing step comprises managing at least one of an ingress rate and an egress rate of the ingress buffer and the egress buffer, respectively, of any of the at least one switch, the at least one server and the plurality of clients.

9. The method of claim 1, wherein the local area network includes at least one switch, and the method further comprises providing an indication to a transmitting device of one of a current or an imminent overflow condition in a receiving device, wherein the transmitting device and the receiving device may be any of the at least one switch, the at least one server, and the plurality of clients.

10. The method of claim 1, further comprising limiting a TCP window size of at least one of the plurality of clients to constrain an amount of data capable of being sent therefrom.

11. A method for managing a Local Area Network (LAN) having at least one video server in signal communication with a plurality of clients, the method comprising:
establishing a lossless Transmission Control Protocol/Internet Protocol (TCP/IP) Virtual Local Area Network (VLAN) fabric within the LAN;
establishing a shared file system on the at least one video server; and
deterministically managing access to the shared file system on the at least one video server by the plurality of clients, over the VLAN fabric, utilizing at least one Internet Small Computer System Interface (ISCSI) block protocol, to provide lossless delivery of applications from the at least one video server to any of the plurality of clients without invoking TCP error recovery mechanisms.

12. The method of claim 11, wherein said managing step comprises managing bandwidth and latency to provide the access to the shared file system at wire speed over the VLAN fabric.

13. The method of claim 11, wherein said managing step comprises:
configuring at least one of the plurality of clients as ISCSI initiators; and
configuring at least one storage element of the at least one video server as an ISCSI target.

14. The method of claim 13, wherein said managing step comprises utilizing ISCSI bridge processing with a dedicated buffer pool in the at least one video server.

15. The method of claim 11, further comprising utilizing the VLAN fabric to segregate network traffic based on traffic type so as to provide uniform traffic patterns.

16. The method of claim 15, wherein said utilizing step comprises:
configuring at least one VLAN to carry only isochronous traffic;
configuring at least one other VLAN to carry only non-isochronous traffic.

17. The method of claim 16, wherein the LAN comprises at least one switch, and the method further comprises configuring the at least one switch to direct only the isochronous traffic to the at least one VLAN and to direct only the non-isochronous traffic to the at least one other VLAN.

18. The method of claim 16, further comprising:
configuring each of the plurality of clients to have at least one port for communicating with the at least one VLAN that carries the isochronous traffic; and
configuring each of the plurality of clients to have at least one other port for communicating with the at least one other VLAN that carries the non-isochronous traffic.

19. The method of claim 11, wherein the LAN includes at least one switch, each of the at least one video server and the plurality of clients includes a network interface card, each of the at least one switch and the network interface card include an ingress buffer and an egress buffer, and said managing step comprises managing at least one of an ingress rate and an egress rate of the ingress buffer and the egress buffer, respectively, of any of the at least one switch, the at least one video server and the plurality of clients.

20. The method of claim 19, wherein said step of managing the at least one of the ingress rate and the egress rate comprises utilizing a flow control function of the any of the at least one switch, the at least one video server and the plurality of clients.

21. The method of claim 19, wherein said step of managing the at least one of the ingress rate and the egress rate is performed so as to prevent invoking of TCP error recovery mechanisms.

22. The method of claim 11, wherein the LAN includes at least one switch, and the method further comprises providing an indication, to a transmitting device, of one of a current or an imminent overflow condition in a receiving device, wherein the transmitting device and the receiving device may be any of the at least one switch, the at least one video server, and the plurality of clients.

23. The method of claim 11, further comprising limiting a TCP window size of at least one of the plurality of clients to constrain an amount of data capable of being sent therefrom.

24. The method of claim 23, wherein said limiting step limits the TCP window size of each of the plurality of clients such that a product of the TCP window size and a number of the plurality of clients does not exceed a bandwidth capability of any data passing element within the LAN.
